(19) United States
(12) Patent Application Publication
(10) Pub. No.: US 2007/0168452 A1
(43) Pub. Date: Jul. 19, 2007

(54) Method of processing data, a network analyser card, a host and an intrusion detection system

(76) Inventor: Howard William Winter, Southampton (GB)

Correspondence Address: PILLSBURY WINTHROP SHAW PITTMAN, LLP, P.O. BOX 10500, MCLEAN, VA, 22102, US

(21) Appl. No.: 10/576,876

(22) PCT Filed: May 20, 2005
(86) PCT No.: PCT/GB05/01994

§ 371 Date: Jan. 10, 2007

Related U.S. Application Data
(60) Provisional application No. 60/572,762, filed on May 21, 2004.

(51) Int. Cl. G06F 15/167

(52) U.S. Cl. 709/213

(57) ABSTRACT

The present invention relates to a method of processing data. The method includes receiving data from a network link; replicating said data no board a network analyser card to produce at least two editions of the received data; and writing said editions of the received data to an area of memory in a host that is directly accessible by a host application. The invention also relates to a network analyser card for connection to a host and a network, the card including a receiver for receiving plural data frames from a network link; data replication means for generating at least two replica editions of the received data frames; and a descriptor adder configured and arranged to add a descriptor to substantially each of the data frames of each of the at least two replica editions of the received data frames, the descriptor including data about the data frame to which it is attached for use in processing of the data frame.

The present invention relates to a method of processing data, a network analyser card, a host and an intrusion detection system.

Network-connected computer systems are increasingly being provided with Intrusion Detection Systems (IDSs) to detect and in some cases filter out attacks made on their systems from the network to which they are connected by hackers, spies, those with criminal intent and the like. IDSs work in part by scanning data in received data packets and applying rules to decide whether the data packet or a group of packets is malicious or unwanted. As the intrusion attempts become more sophisticated, more rules need to be applied to detect the intrusion attempts and so IDSs become more computationally intensive.

In addition, the data rate on networks is increasing thus increasing the rate at which a processor or central processing unit (CPU) analysing the received data packets has to work to keep up with the traffic. To address this, IDS have been developed that utilise two or more processors or CPUs to perform the rules analysis. This in turn means that a way has to be found to share out the work i.e. the execution of rules on received data packets, between the processors.

Another trend within the network-connected computer industry is for multiple functions (IDS, Firewall, Network Analysis, Packet Capture) to be performed in the same host. This requires a method and apparatus by which data received at the host from a network to which the host is connected, can be provided to each of the multiple functions.

Referring to the example of IDSs a number of different approaches exist to address the problem of sharing the rules analysis involved in IDS between two or more (e.g. a number N) processors.

The first approach involves sharing the traffic between the N processors, each of which applies all the rules to the traffic it receives. The device doing the traffic sharing is sometimes called a load balancer, because in use it attempts to share the received traffic equally between the N processors. If each processor receives 1/N of the total traffic then the traffic handling ability is N times that of a single processor (barring any system issues limiting the independence of the CPUS).

A second approach is to share the rules necessary to perform the IDS between the N processors so that each processor only applies a sub-set of the rules to the received network data. Using this approach, each of the N processors receives all the traffic so that every data packet received has every rule applied to it somewhere. If each processor applies 1/N of the rules (measured by the number of processor cycles needed to process a rule) then the rule handling ability of such an IDS is N times that of a single processor. This is equivalent to being able to handle N times the traffic of a single processor.

A third approach is to write or re-write IDS software executed by the processors into a version which runs on several processors. This is commonly referred to as multi-threading. A simple example would be to build a software equivalent of an external load balancer which runs on one processor, and which is arranged to divide out data packets to other processors each of which is applying all the rules. In effect, this is a software implementation of the first approach explained above.

In all these cases, a full performance gain is only realised if all N processors are kept fully occupied. This means that the sharing of data packets and/or rules between the processors has to be performed properly.

There are a number of problems with the approaches described above. Referring to the first approach, load balancer devices cannot blindly distribute received data packets to any of the N processors. The load balancer device needs to be aware that an attempted intrusion may consist of several data packets. To be detected as an intrusion a group of such packets must all be sent to the same one of the N processors. If the packets within the group are split between two or more of the N processors the correlation between the packets may not be seen and intrusion would not be detected. Hence, the load balancer needs to have intelligence and the ability to maintain state information about which packets have been passed to which processors. This makes the load balancer a complex and expensive device, particularly at high data/packet rates.

In addition, in some cases an IDS may be placed in front of a firewall (to detect intrusions that the firewall might filter out) and/or behind the firewall (to detect intrusions from within a user's system and those that successfully get through the firewall). In either case this makes the IDS, and the load balancer in particular, vulnerable to such attacks. Making the load balancer attack-resistant may add to its complexity and cost.

Referring to the second approach explained above, since each of the N processors has to receive all the data, the amount of data flowing in the system has been multiplied by N. The system handling the network data, including the operating system (OS) and the memory system must be able to cope with this increased data rate. In addition, means to replicate the data and essentially generate N editions of the data, must be provided. This may be done by beam splitters when optical fibre is conveying the data or by electronic means of the data is being conveyed using e.g. copper wires. In both cases, this adds complexity and costs to such a system.

Referring to the third approach, it is not always easy to write or re-write complex software such as IDS software to make efficient use of multiple processor systems. Some of the processes used in IDS are inherently serial in nature and therefore unsuited to direct parallel or multi-thread implementation. Furthermore, the performance of a software load balancer will be inferior to that of a hardware one (such as that used in the first approach described above) and will use up system memory.

Thus far, discussion has been predominantly in relation to issues and problems associated with Intrusion Detection Systems. It will be appreciated that similar or corresponding problems are encountered whenever multiple functions are provided in the same host. Examples of the functions include, firewall functionality, network analysis and packet capture.

According to a first aspect of the present invention there is provided a method of processing data, the method comprising: receiving data from a network link; replicating said data on board a network analyser card to produce at least two editions of the received data; and writing said editions of the received data to an area or areas of memory in a host that is directly accessible by a host application.

This aspect of the invention provides a method of processing data in which data received from a network link is replicated such that at least two editions of the received data packets are produced. The at least two editions are then stored within an area of memory on a host, the area of memory being directly accessible by a host application. Accordingly, in contrast to conventional systems in which data is written to a host memory and then copied from one part of the host memory to another for processing, in the present invention the data is written to an area of the memory that is directly accessible to an application that may be running on the host.

By replicating the data on board the network analyser card, no processing capacity (or processor cycles) of the host processor is used for copying data packets, thus enabling the host processor or processors to assign a greater proportion of their processing capacity to applications running on the host.

Preferably, the method comprises processing said editions of data stored in the said area of memory accessible by a host application, the processing comprising executing a different set of rules relating to intrusion detection on each edition. Some rules may be executed on more than one of the editions.

In a preferred example, data stored in the area of memory accessible by a host application, comprises executing rules relating to intrusion detection. Since the data is written to an area of host memory directly accessible by the host application (intrusion detection in this case), the host operating system is not required to perform copying of the data and accordingly has increased capacity for other processing functions.

Since at least two editions of the data are generated each may be processed by a different processor in the host. Accordingly, the Intrusion Detection System benefits from the capability of fast processing enabled by sharing of rules amongst plural processors whilst simultaneously data transferred to the host does not need to be copied from kernel space to application space within the host memory and so memory requirements of the host may be controlled.

An example of the method of the present invention provides similar advantages to all network monitoring/analysis applications, particularly those that are single threaded and that are run in a multiprocessor host. In addition, the invention enables the different applications to run independently without a reliance on a software or hardware load balancer which may slow all of the applications down, if only one of the applications does not obtain its data efficiently.

Examples of the invention may be used for any suitable network monitoring management or analysis applications. Examples include RMON II (Network monitoring/statistical analysis) probes, IDS/IDP, Billing/mediation, network monitoring, behaviour characterisation and trouble shooting etc.

According to a second aspect of the present invention there is provided a network analyser card for connection to a host and a network, the card comprises a receiver for receiving plural data frames from a network link; data replication means for generating at least two replica editions of the received data frames; and a descriptor adder configured and arranged to add a descriptor to substantially each of the data frames of each of the at least two replica editions of the received data frames, the descriptor including data about the data frame to which it is attached for use in processing of the data frame.

According to a third aspect of the present invention there is provided a host for connection to a network, the host comprising a network analyser card for receiving data from the network; a memory to receive at least two editions of the received data from the network analyser card; and at least two processors for processing said editions of the received data, wherein the network analyser card is in accordance with the second aspect of the present invention.

According to a fourth aspect of the present invention there is provided an intrusion detection system, comprising a host according to the third aspect of the present invention, wherein the processor is arranged to execute rules of an intrusion detection system on data packets received by the host.

Since the rules analysis of the intrusion detection system is shared amongst two or more processors the intrusion detection system is able to perform the intrusion detection relatively quickly. Furthermore, by ensuring that data received from the network is replicated and written to an area of host memory directly accessible to the intrusion detection application, the benefits described above in relation to this feature are also achieved.

According to another aspect of the present invention, there is provided a method of processing data, the method comprising receiving data from a network link; replicating said data to produce at least two editions of the received data; and writing said editions of the received data to an area or areas of memory in a host that is directly accessible by a host application.

Examples of the present invention will now be described in detail with reference to the accompanying drawings, in which:

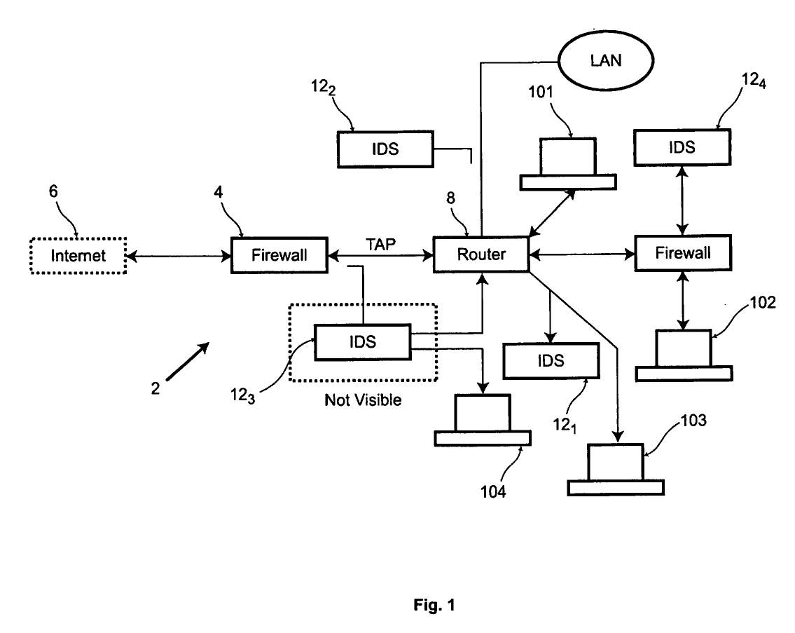

FIG. 1 shows a schematic representation of a communication system;

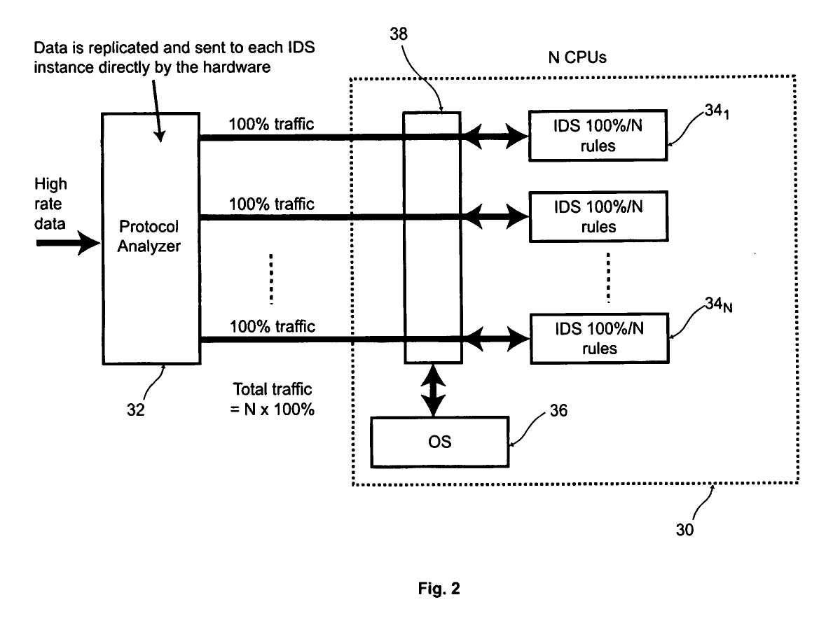

FIG. 2 shows a schematic representation of an intrusion detection system;

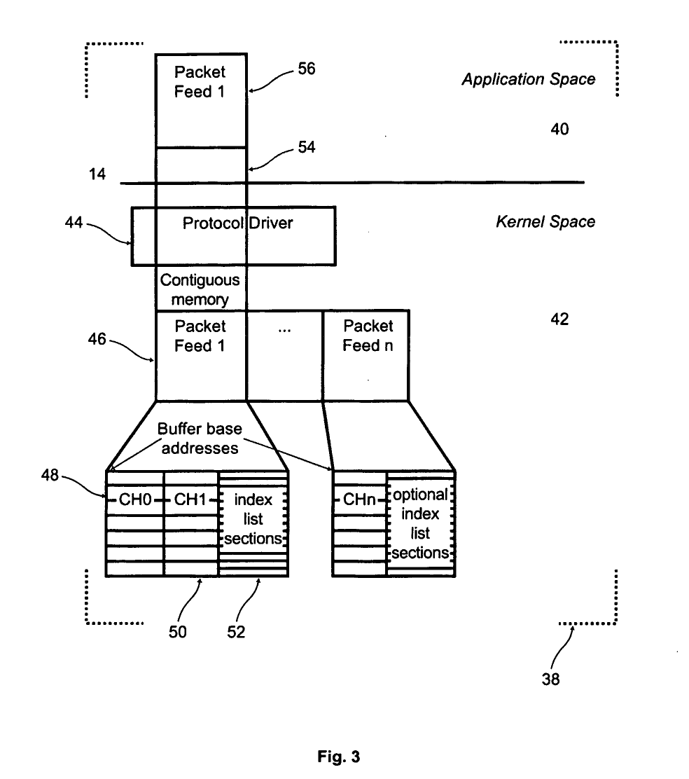

FIG. 3 shows a schematic representation of a memory;

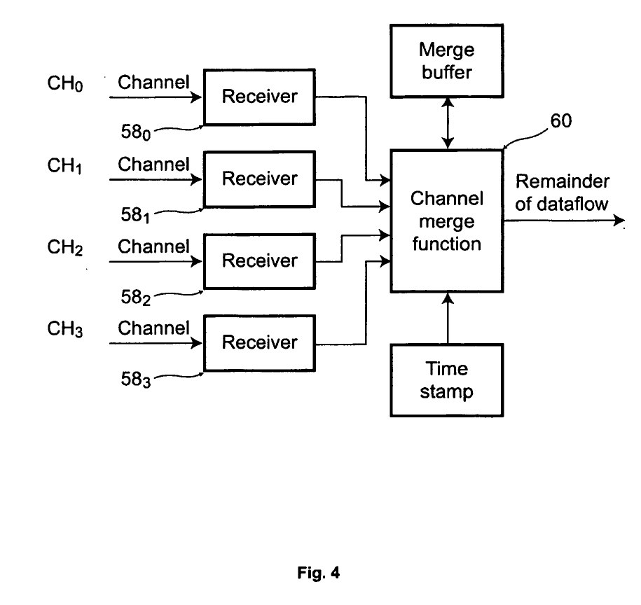

FIG. 4 shows a schematic representation of a channel merge function;

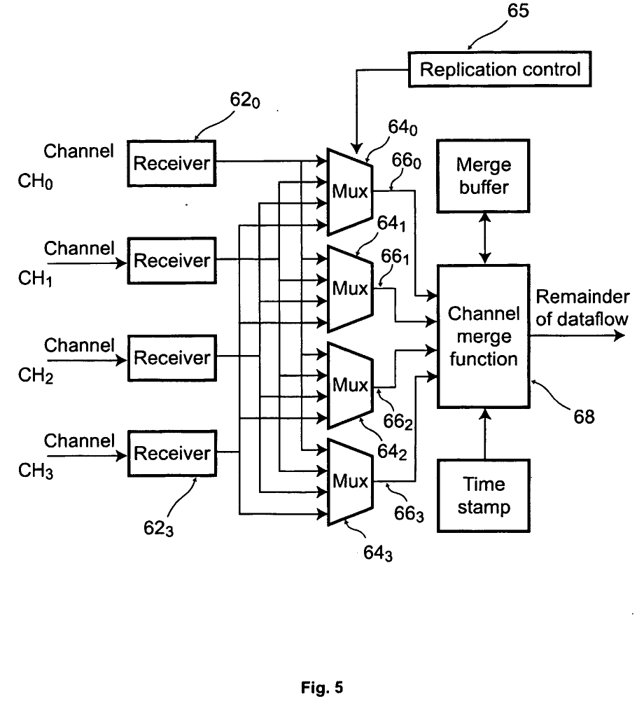

FIG. 5 shows a schematic representation of channel merge function including a data replication function;

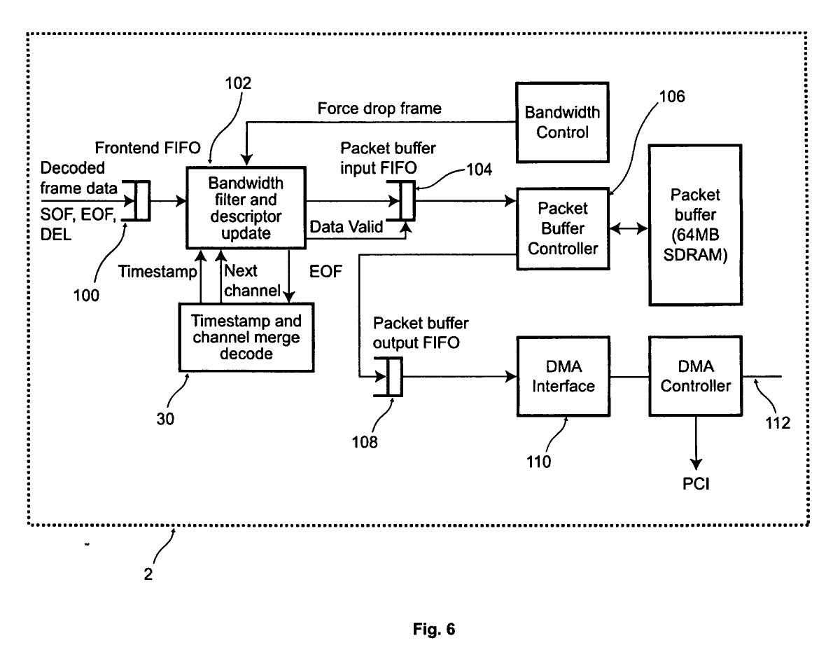

FIG. 6 shows a schematic block diagram of a stream packet function embodied on a network analyser card;

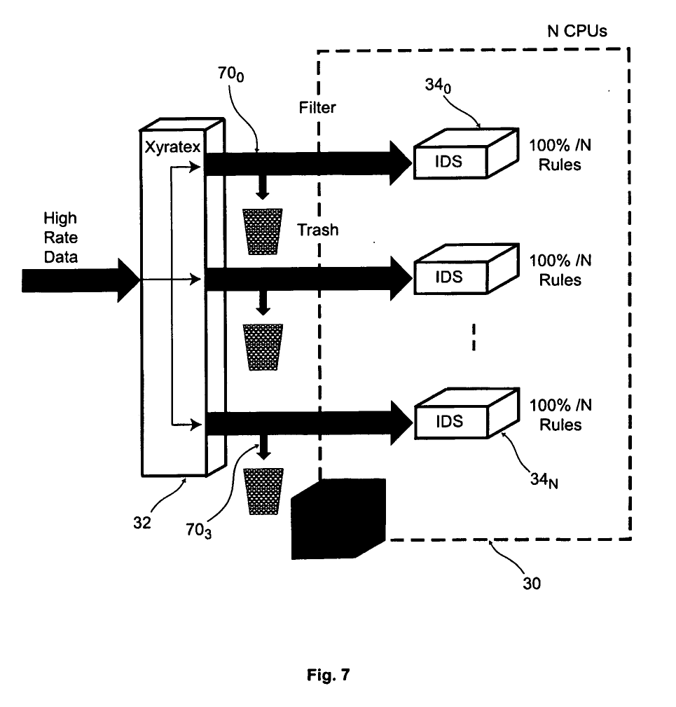

FIG. 7 shows a schematic representation of a data flow;

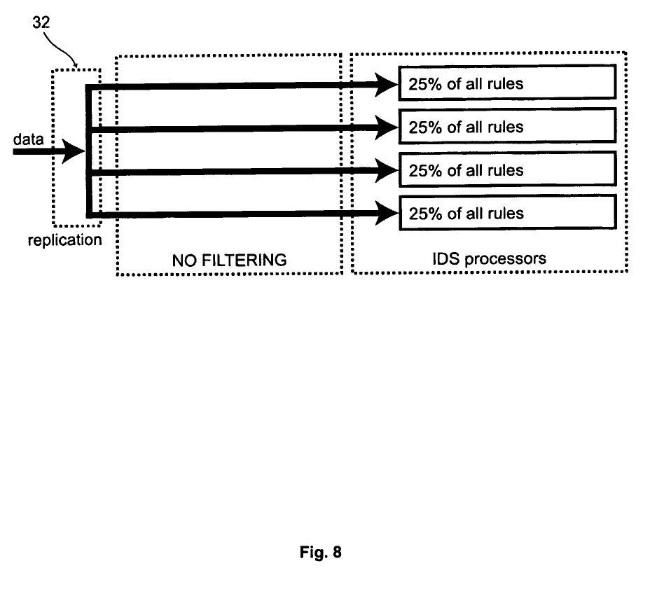

FIGS. 8 to 11 show schematic representations of data flows in which different filtering arrangements are provided.

FIG. 1 shows a schematic representation of a communication system. The communication system 2 is shown connected via a firewall 4 to the Internet 6. The communication system 2 comprises a number of components typically provided in such a communication system. The communication system 2 is merely one possible example of such a system. Any combination of the components shown with more or less of the same or different components may be provided in such a communication system.

Referring to the example in FIG. 1, the communication system comprises a router 8 connected via the firewall 4 to the Internet 6. The router 8 serves to route information in both directions between the Internet 6 and a number of user terminals 10₁ to 10₄. A number of intrusion detection systems 12₁ to 12₄ are provided at various points within the communication system 2. Referring to the intrusion detection system 12₃, this is connected via an optical tap to the communication channel between the firewall 4 and router 8. The IDS 12₃ is arranged to receive a copy of all data received by the router 8 from the Internet 6. It is then able to process this received data to determine whether or not an intrusion to the communication system 2 is occurring. The role, function and method of operation of the intrusion detection system will be described in more detail below.

At least some of the intrusion detection systems 12₁ to 12₄ are preferably arranged in communication with a firewall 4 such that if an intrusion is detected the firewall can be informed of the type of intrusion and updated so that in future such intrusions are rejected.

FIG. 2 shows a schematic representation of an example of an IDS including a host and a network analyser card according to an embodiment of the present invention. In the example shown, a host 30 is provided connected to a network analyser card 32. The network-analyser card 32 is shown as a separate add-in card. This need not necessarily be the case and in an alternative the card may be an embedded system within the host 30. The network analyser card 32 is connected to a network (not shown) optionally via a number of intermediate components such as a router/switch 8 as shown in and described briefly above with reference to FIG. 1. Typically the network analyser card 32 is connected to the network via a tap or router/switch ‘SPAN’ port, i.e. a port that provides a copy or mirror of all traffic going through the router/switch and is commonly used for monitoring.

The host 30 comprises N central processing units 34₁ to 34_{N}. An operating system 36 and a memory 38 are provided on board the host 30. Many other components may typically be included in the host although for clarity they are not shown in FIG. 2.

In the example shown, each of the processors 34₁ to 34_{N} is arranged to execute a predetermined number of rules from a complete set of rules of an IDS. In this example each of the processors 34₁ to 34_{N} is arranged to execute 100%/N of the rules of the IDS. Any suitable distribution of rules between the CPUs 34₁ to 34_{N} may be used. One or more of the processors may be provided with more than 100%/N and one or more of the processors may be provided with less than 100%/N of the rules. Overall it is required that each of the rules of the IDS is executed by at least one of the CPUs. Of course, as mentioned above, although this description refers to an IDS it will be appreciated that the system and method described are equally applicable to many other types of application in which multiple functions are performed on data received from a network link.

Referring again to FIG. 2, in use, data received by the network analyser card 32 from the network is replicated by the network analyser card 32 and provided to the memory 38. The originally received data is replicated such that N editions of the data are generated and all are written to the memory 38 in such a way that the processors 34₁ to 34_{N} between them running the IDS application, can access the data directly. This means that in contrast to conventional systems in which data is received into kernel space of a memory and then copied by the operating system into application space for use by associated processors, in the present case the data may be accessed directly from the physical location to which it was written by the network analyser card 32. Accordingly, host processing capacity is not required for copying data from the physical kernel space to the physical application space of the host memory.

FIG. 3 is a schematic representation of the memory 38 shown in the host 30 of FIG. 2. The memory 38 comprises application space 40 and kernel space 42. As explained above with reference to FIG. 2, N editions of the received data are all written to an area or areas of the memory 38 in such a way that the processors 34₁ to 34_{N} running the IDS application can access the data directly. Referring to FIG. 3, the received data is written directly into the kernel space 42 of the host memory 38. A protocol driver 44 is provided that enables an application running in application space 40 of the memory 38 to directly access the data stored in the kernel space 42 of the memory 38.

Accordingly, instead of having to copy data from the kernel space to a corresponding region of the application space 40 of the memory 38, the data is accessed directly from the application space and accordingly copying of the data is not required. This increases the efficiency of the host CPUs since they do not have to perform any copying of the data for this purpose. In addition the memory requirement can be reduced since copies of the received data do not need to be made for this purpose. The received data in this context refers to all data received in the memory 38 from the network analyser card 32.

The ability to provide access to data stored in kernel space to an application running in application space of the memory 38 is achieved with the use of offsets and virtual base addresses. As data is received into the physical memory in kernel space 42, a list of offsets is generated with respect to a base address within kernel space 42. Conventionally, this data would then all be copied to a physical region within application space 40 of the memory 38. However, in an example of the present invention, instead of copying the data, the list of offsets is passed by the protocol driver 42 to the application running in application space 40.

This list of offsets includes an offset in respect of the base address of the region 46 and the list of offsets used with respect to the base address in kernel space 42. In other words, an offset to a list of offsets is provided to an application running in the application space 42. This enables the application running in application space 40 to directly access the data stored in the kernel space by using an offset to locate the base address of the region 46 within kernel space 42 and subsequently the list of offsets with respect to that offset. This mapping is enabled by the protocol driver 44 that, in this example, is arranged to provide the offsets to the application space 40. Memory within the region 46 is contiguous memory to enable correct location of data stored within kernel space by the application running in application space 40 with the use of the offsets described above.

In FIG. 4, a part of a network analyser card 32 is shown receiving data from a network (not shown) on four external channels CH₀ to CH₃. For ease of processing of the data, it is known to merge the plural channels into a single serial data stream. This is shown schematically in FIG. 4 by the provision of a channel merge function 60.

In FIG. 4, four channel receivers 58₀ to 58₃ are shown. Each receiver 58₀ to 58₃ is arranged to receive data from a corresponding channel CH₀ to CH₃. The receivers 58₀ to 58₃ are arranged to provide the data received from the corresponding channel to the channel merge function 60. Any suitable channel merge function may be used. Preferably, the channel merge function described in U.S. Provisional Application No. 60/495,133 is used, the entire contents of which are hereby incorporated by reference. The output from the channel merge function is provided to the memory of the host such as the memory shown schematically in FIG. 3.

FIG. 5 shows a modified version of the network analyser card in which a replication function is provided. Like the data flow shown in FIG. 4, in FIG. 5, data is received on four external channels CH₀ to CH₃ by corresponding receivers 62₀ to 62₃. A plurality of replication units 64₀ to 64₃ is provided. In the example shown each replication unit comprises a multiplexer although any suitable means for replicating data may be provided.

The outputs from each of the receivers 62₀ to 62₃ are connected to each of the replication units 64₀ to 64₃. A replication control unit 65 is provided to control the replication units 64₀ to 64₃. Under control of the replication control unit 65 the output of any of the receivers 62₀ to 62₃ can be selected to appear on the output of a replication unit 64₀ to 64₃. Many combinations are possible, from making the output of one receiver appear on the outputs of all the replication units (in this case giving the maximum amount of replication, the outputs of the other receivers being ignored), to making the output from each receiver appear on the output of its corresponding replication unit.

In this case there is no replication and this case is mentioned to show that a non-replicating mode of operation is still possible. Each of the replication units 64₀ to 64₃ is shown in this example to be a multiplexer having a respective output 66₀ to 66₃ coupled to a channel merge function such as that shown in and described above with reference to FIG. 4. Preferably the replication units are embodied in hardware such as an FPGA.

The outputs from the replication units 64₀ to 64₃ define independent internal channels within the network analyser card 32. The internal channels (64₀ to 64₃) are distinct and independent and not to be confused with the external channels (CH₀ to CH₃) on which data is received by the network analyser card 32 from an external network.

The channel merge function 68 receives the output from each of the multiplexers 64₀ to 64₃ and merges data on the four internal channels into a merged serial data stream. The channel merge function 68 then provides the merged serial data stream to a host for writing to the memory of the host. In the case of maximum replication the flow of data from each of the replication units 64₀ to 64₃, is in fact identical. However, the channel merge function 68 treats each of the signals 66₀ to 66₃ as if it were an independent channel for processing. This enables selective filtering to be performed on the signals 66₀ to 66₃, as will be explained in detail below.

Once the replicated data has been merged by the channel merge function 68 the merged serial data stream is preferably passed to further processing functionality on or off board the network analyser card so that it may be written to host memory as described above with reference to FIG. 3. One suitable example of functionality capable of performing this is described in U.S. provisional patent application No. 60/528,717, the entire contents of which are hereby incorporated by reference. In U.S. provisional patent application No. 60/528,717 there is described in detail a stream packet feed function of a network analyser card for handling data frames/packets received from a network. FIG. 6 shows a schematic block diagram of the stream packet feed function shown in and described in detail in US 60/528,717.

Referring to FIG. 6, a front end First In First Out (FIFO) 100 is provided for receiving a serial data stream from an upstream source. The upstream source may be a merged data stream such as that output by the arrangement shown in FIG. 5.

The front end FIFO 100 is connected to a bandwidth filter and descriptor update unit 102. This unit 102 is connected to an input FIFO 104 which itself is connected to a packet buffer controller 106 and via a further FIFO 108 to a direct memory access (DMA) interface 110 and controller 112. In use, data is transferred from the channel merge function 68 in a merged data stream, to the front end FIFO 100. From the front end FIFO 100 it is sent to the bandwidth filter and descriptor update unit 102. At this stage, a data packet descriptor is added to at least some and preferably all of the data frames in the merged data stream, a frame with its corresponding descriptor being referred to herein as a data packet.

The data packet descriptor has fields that may be used to indicate a number of parameters relating to the data packet with which it is associated. Importantly, the descriptor includes a field used to indicate the length of the data frame to which it is attached. This enables generation of the offsets referred to above that may be used to locate the data packet within host memory, as explained above with reference to FIG. 3. In addition, the descriptors may be used to group data for transfer to the host memory so that fewer interrupts of the host CPUs need to be generated. The descriptor preferably also includes a field used to indicate the time at which the data frame to which it is attached was received and a field to indicate the channel from which the data frame was received.

The data flows shown in FIGS. 5 and 6 are preferably arranged on a common network analyser card.

FIG. 7 is a schematic representation of a data flow including a network analyser card 32 and a plurality of processors 34₁ to 34_{N} arranged on a host 30. Each of the boxes numbered 34₁ to 34_{N} in FIG. 7 actually represents a processor and its logically associated memory. In the example shown, data is received by the network analyser card 32, replicated as described above with reference to FIG. 5 and written to a memory on board the host 30 as explained above with reference to FIG. 3. Although shown as parallel streams 70₀ to 70₃ for clarity, the output from the network analyser card preferably comprises a merged serial data stream.

In one example, the memory 38 is in fact a single physical memory of which the operating system allocates sections to each of the processors 34₁ to 34_{N}, so that logically each processor has a dedicated separate section of memory. In other words, there is a single physical memory but there are separate logical memories. It is also possible that there may be areas of memory common to all the processors, i.e. areas of memory which all the processors can access.

The physical memory may be implemented on plural separate cards within the host and indeed this will often be the case, but it is still thought of as a single physical memory. Alternatively, it could be that a certain amount of memory is packaged with each of the processors and for performance reasons a host operating system allocates each such memory to its physically associated processor. It is preferable that physically there is effectively one memory that the network analyser card 32 sees as it transfers data to the host.

The network analyser card 32 may be set up by driver software in conjunction with the host operating system to write and store each internal channel's data in a separate section of that memory. The sections of memory to which the data is written by the network analyser card 32 each logically belong to a different processor.

In one possible example, the network analyser card 32 has interfaces to several separate physical memories. In general then, referring to FIG. 7, each of the processors 34₁ to 34_{N} has logically associated memory which may or may not be physically separate from the respective processor and/or the other memories.

In the example shown in FIG. 7, a number of editions of a received data stream are shown emerging from the network analyser card 32. A filter 70₀ to 70_{N} is applied to each of the editions, so in this example N=3. FIG. 5 shows four channels, four receivers and four replication units etc, whereas FIG. 7 shows a more general situation in which there are N processors. This is reflected in the numbering 34₀ to 34_{N}. After replication, the signals 66₀ to 66₃ are analogous to multiple independent channels and as explained above may be referred to as internal channels. Accordingly, each of the filters 70₀ to 70_{N} may be used to work on its corresponding signal as an independent channel.

In dependence on the profile of traffic, filtering can be used to reduce the data provided to each of the processors 34₀ to 34_{N} provided by filters 70₀ to 70_{N} and hence improve performance. For example, filtering could be used to limit data in dependence on the communications protocol on which it is based (Internet Protocol, User Datagramme Protocol, Transmission Control Protocol, etc.), network “port” or “address” range. The combination of replication and filtering of the independent editions of the data allows a better balance for the effect of rules and data rate on performance across multiple CPUs. Accordingly, the rules and operation of each of the individual CPUs may be matched to the received traffic received at that particular CPU.

FIGS. 8 to 10 show schematic representations of data flows in which different filtering arrangements are provided. Referring to FIG. 8, if there are four channels in total and no filter is used on any of the internal channels, a simple division of 25% of the rules being executed by each of the four CPUs may be used. For example, the outputs from the filters in each of FIGS. 8 to 10 are shown as four parallel streams. It is likely that the four parallel streams will be merged either before or after filtering into a single serial data stream. A channel merge function may be used, such as that described above with reference to FIG. 5.

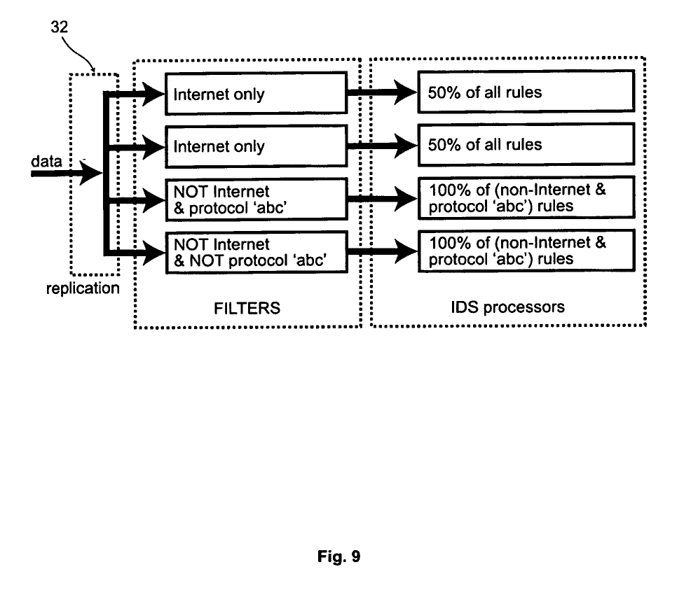

Referring to FIG. 9, if two of the internal channels are filtered so that only Internet traffic is allowed to pass, a third of the internal channels is filtered so that traffic that is not Internet traffic but is of a particular communications protocol e.g. protocol ‘n’, is allowed to pass, and the fourth internal channel is filtered so that all other kinds of traffic, i.e. traffic which is not Internet traffic and which is not of the particular communications protocol, is allowed to pass, then the rules used by the processors to which the data is copied may be only provided with the specific rules required.

For the example given above, two of the four processors will be provided with 50% each of the rules relating to Internet traffic, the third processor will be provided with rules relating to the communications protocol ‘n’ and the fourth of the processors is provided with all of the non-Internet rules that do not relate to the communications protocol ‘n’.

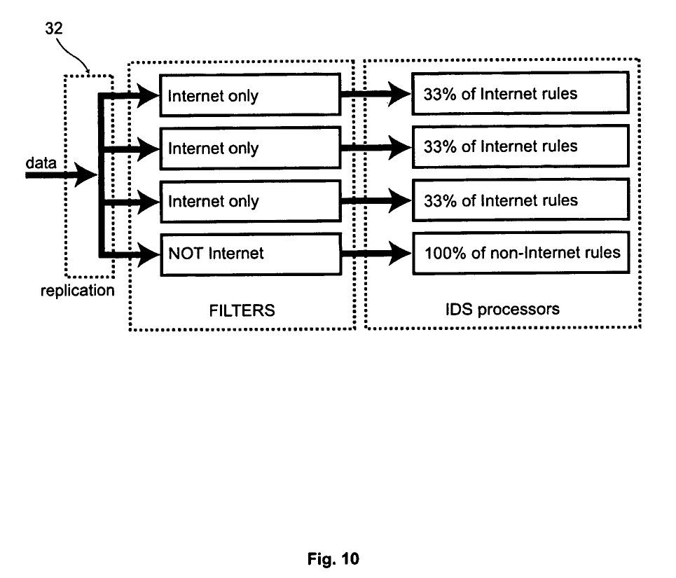

Referring to FIG. 10, in this case, three of the four filters are arranged only to pass Internet traffic whereas the fourth filter is arranged only to pass non-Internet traffic. Accordingly, the rules used by the processors to which each of the filters provides data are selected accordingly. In the example shown, three of the filters are each arranged to run 33% of the IDS rules relating to Internet traffic and the fourth of the filters is arranged to run 100% of the rules relating to non-Internet traffic.

In other words, the first three of the data streams received from the network analyser card 32 are filtered so that only Internet traffic is maintained in the merged signal. The fourth is filtered so that only non-Internet traffic is maintained in the merged signal. The three processors that are arranged to receive each of the three Internet signals are each provided with a different third of the Internet rules of the IDS. The fourth processor is provided with 100% of the non-Internet rules.

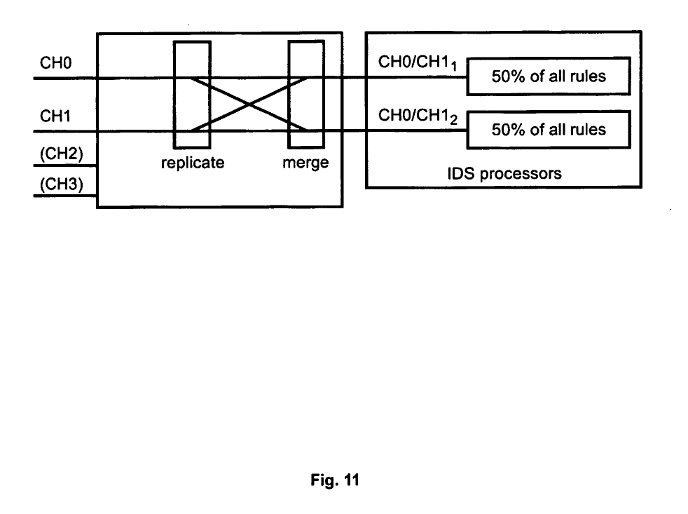

FIG. 11 shows an example of a data flow including a network analyser according to another embodiment of the present invention. In this case, two channels CH0 and CH1 are received at a network analyser card 32. The channels are replicated as explained above, and the replicated channels are merged into internal channels CH0/CH1₁ and CH0/CH1₂. The host in this example is provided with two IDS processors, each of which is arranged to execute a different 50% of the rules of the IDS so that in total, all of the received data will be processed by all of the rules of the IDS.

It will be appreciated that numerous modifications to and departures from the preferred embodiments described above will occur to those having skill in the art. Thus, it is intended that the present invention covers the modifications and variations of the invention, provided they come within the scope of the appended claims and their equivalents.

1. A method of processing data, the method comprising:
receiving data from a network link;
replicating said data on board a network analyser card to produce at least two editions of the received data; and
writing said editions of the received data to an area of memory in a host that is directly accessible by a host application.

2. A method according to claim 1, comprising:
processing said editions of data stored in the said area of memory accessible by a host application, the processing comprising executing a different set of rules relating to intrusion detection on each edition.

3. A method according to claim 1, in which the data is replicated using hardware.

4. A method according to claim 1, in which the editions of the received data are provided as independent data streams.

5. A method according to claim 1, in which each of the at least two editions of said received data is buffered independently.

6. A method according to claim 4, in which each of the independent data streams is filtered according to desired criteria.

7. A method according to claim 4, in which different filtering rules are applied to each of the editions of the received data.

8. A method according to claim 1, the method comprising:
writing the editions of the received data to an area of kernel memory of the host memory; and
providing to the host application an offset to enable location of the data by the host application in the kernel space of the memory.

9. A method according to claim 8, in which when data is written to the kernel space of the host memory a list of offsets with respect to a base address within kernel space is generated, the list of offsets serving to enable location of data packets within the kernel space with respect to the base address.

10. A method according to claim 9, comprising:
providing to an application for running in application space, an offset to enable location of the base address of the data within the kernel space.

11. A method according to claim 9, comprising:
providing to the application a list of offsets with respect to the offset of the base address.

12. A method according to claim 1, in which the data is received as data frames from a network link.

13. A method according to claim 12, comprising:
adding to substantially each of the received data frames a descriptor, the descriptor containing data relating to the data frame to which it is attached.

14. A network analyser card for connection to a host and a network, the card comprising:
a receiver for receiving plural data frames from a network link;
data replication means for generating at least two replica editions of the received data frames; and
a descriptor adder configured and arranged to add a descriptor to substantially each of the data frames of each of the at least two replica editions of the received data frames, the descriptor including data about the data frame to which it is attached for use in processing of the data frame.

15. A network analyser card according to claim 14, comprising:
data writing means for writing the at least two replica editions of the received data frames to an area of host memory directly accessible by a host application.

16. A network analyser card according to claim 14, in which the descriptor includes data indicative of the length of a data frame to which it is attached.

17. A network analyser card according to claim 14, in which the descriptor includes a timestamp indicative of the time at which the corresponding data frame was received at the network analyser card.

18. A network analyser card according to claim 14, wherein one or more of the data replication means, the descriptor adder and the data writing means is or are arranged in hardware.

19. A network analyser card according to claim 14, the network analyzer card being controllable to execute the steps of:
receiving data from a network link;
replicating said data on board a network analyser card to produce at least two editions of the received data; and
writing said editions of the received data to an area of memory in a host that is directly accessible by a host application.

20. A host for connection to a network, the host comprising:
a network analyser card for receiving data from the network;
a memory to receive at least two editions of the received data from the network analyser card; and
at least two processors for processing said editions of the received data, wherein the network analyser card is in accordance with claim 14.

21. A host according to claim 20, wherein each of the at least two processors is arranged to execute a different set of rules on each edition of the stored data.

22. A host according to claim 21, wherein the rules relate to intrusion detection.

23. An intrusion detection system, comprising a host according to claim 20, wherein the processors are arranged to execute rules of an intrusion detection system on data packets received by the host.
